(19) United States
(12) Patent Application Publication
(10) Pub. No.: US 2009/0059574 A1
(43) Pub. Date: Mar. 5, 2009

(54) Solar lighting light up blinds

(76) Inventors: Nicole E. Lewis, Cleveland, OH (US); Warren Dixon, III, Cleveland, OH (US)

Correspondence Address: Nicole Lewis Warren Dixon III, 3456 East 69th, Cleveland, OH, 44127, US

(21) Appl. No.: 12/214,802

(22) Filed: Jun. 20, 2008

Related U.S. Application Data
(60) Provisional application No. 60/936,785, filed on Jun. 23, 2007.

(51) Int. Cl. F21L 4/00

(52) U.S. Cl. 362/183

(57) ABSTRACT

A solar lighting light up blinds is provided which consist of a mini blind or various types of window blinds that is mounted within a interior of a frame of a window in a home or a building. An apparatus is carried by the mini blind, for converting solar radiation of sunlight into electrical energy. A mechanism is carried by the mini blind for utilizing the electrical energy to light the led lights. At sunrise and all through the day, the solar panel will charge and at sunset the led lights will illuminate.

### BACKGROUND OF THE INVENTION

1. Field of the Invention

The instant invention relates generally to window coverings and more specifically it relates to a solar lighting light up blinds.

2. Description of Prior Art

Numerous window coverings provided in prior art adapted to be mounted onto window frames, these units may be suitable for the purpose to which they address, they would not be as suitable for the purpose of the present invention as heretofore described.

### SUMMARY OF THE INVENTION

A primary object of the present invention is to provide a solar powered window blind that would rise above and stand out over the other prior art and will overcome the shortcomings of the prior art.

Another object is to provide a solar lighting light up blind that will charge during the day using solar energy and that the led bulbs will light at night. It is very useful for security reasons and if you have a power outage you will have light, and can be used for every day use.

A further object is to provide a solar lighting light up blinds that is simple, easy to use, and economical in cost to manufacture.

To the accomplishments of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

FIG. 1 is a front perspective view of the instant invention mounted inside a window frame in the home or building.

FIG. 2 is a front perspective view of the instant invention.

FIG. 3 is an enlarged view of the control unit.

FIG. 4 is a perspective view of the wireless remote control.

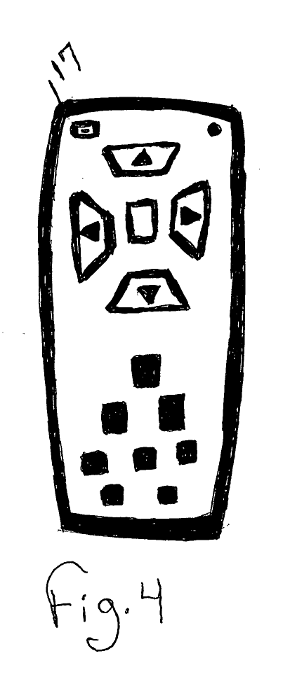

### DETAILED DESCRIPTION OF THE PREFERRED EMBODIMENTS

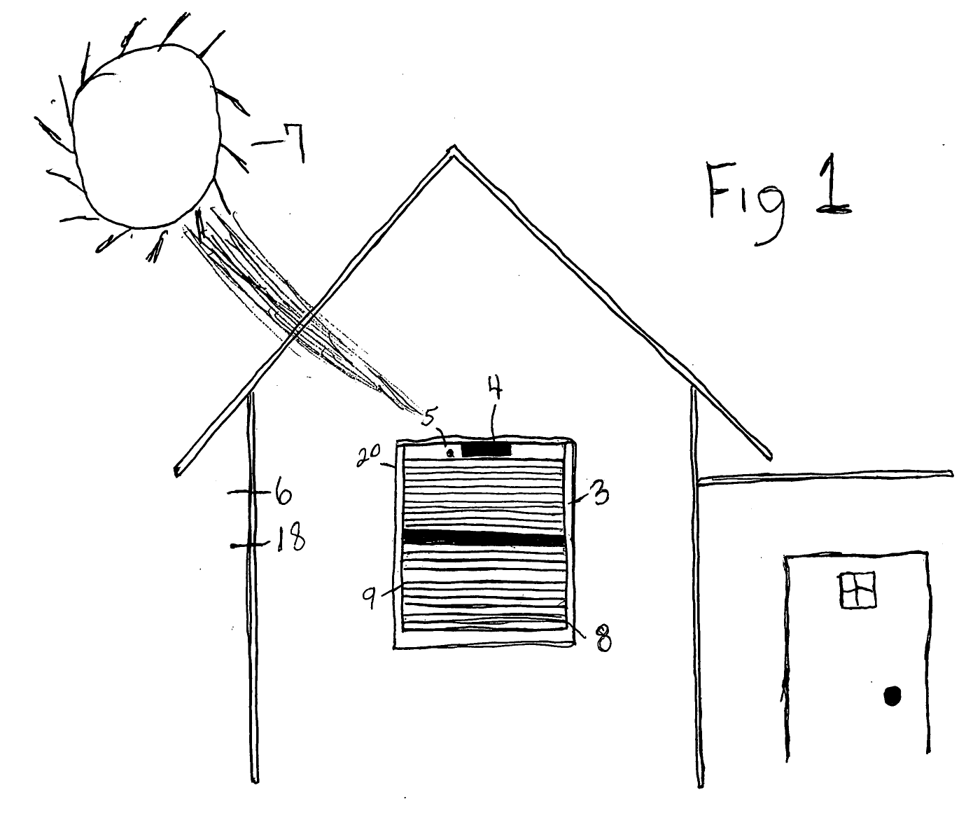

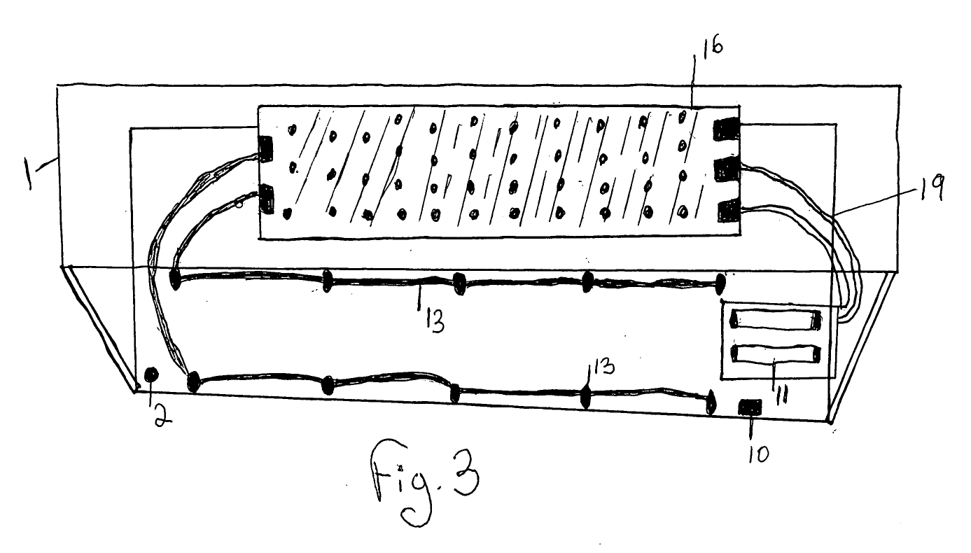

Turning now descriptively to the drawings, FIGS. 1, 2, 3 illustrate a solar lighting light up blind 9 which consists of a mini blind, 9 mounted within an interior of a frame 3 of a window 3 in a home or a building 6 and apparatus 18 is carried by the mini blind 9 for converting solar radiation of sunlight into electrical energy, A mechanism 20 is carried by the mini blind 9 for utilizing the electrical energy to light 13 the mini blinds 9. At sunrise and all through the day the mini blind 9 will charge by the sun 7 through window. At sunset and all through the night the mini blind 9 will light 13 within the home or building 6 for security reasons, power outages, or for personal enjoyment.

The solar radiation converting apparatus 18 includes a solar panel 4 mounted to the head channel 1 facing the window 3 to receive the solar radiation. A plurality of interconnected solar cells 5 are within the solar panel 4, each solar cell 5 converts the solar radiation into the electrical energy.

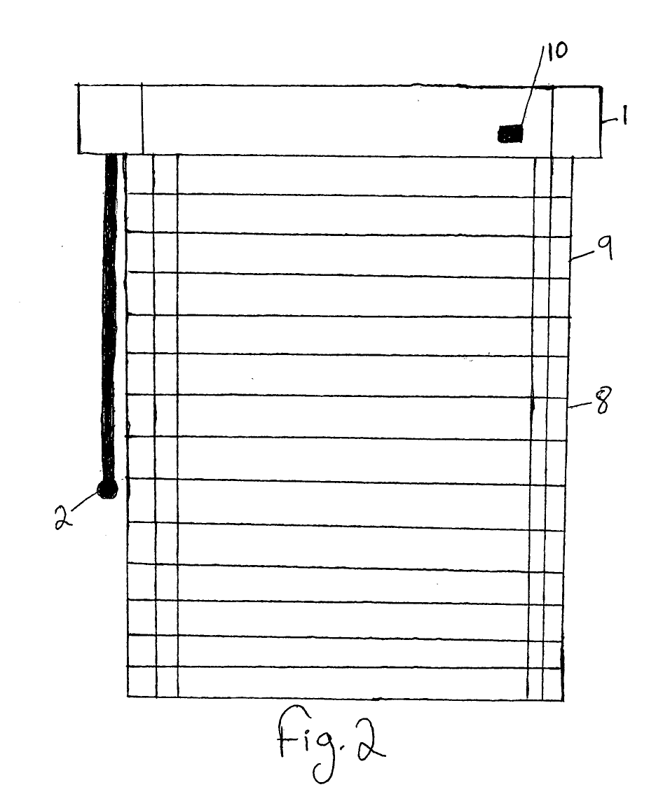

The electrical energy utilizing mechanism as seen in FIG. 2 contains a circuit board 16 mounted within the head channel 1. And as electrically connected to the solar cells 5 within the solar panel 4 so as to be operated by the electrical energy.

A control unit 19 is electrically connected to the battery 11 so that lights 13 can be operated both manually and automatically. the control unit 19 as best seen on FIG. 2 includes a cord 2 suspended to heading down from head channel 1. A sensor 10 is mounted in head channel 1 to utilize the wireless remote control 17 on and off feature.

A battery 11 is carried in the head channel 1 and is electrically connected to the circuit board 16 which is connected to the solar panel which will provide solar radiation to charge the battery 11. A row of led bulbs 13 is also mounted in the head channel 1 best seen in FIG. 2 which will illuminate at night to shine into the home or building 6 so as to make it appear that there is someone in the home or building 6 for security reasons, power outages, or personal use.

### LIST OF REFERENCE NUMBERS

1 head channel
2 on/off switch
9 mini blind
10 sensor
7 sun
6 house
5 photo cell
8 mini blind
4 solar panel
3 window frame
11 battery
13 led bulbs
16 circuit board
17 wireless remote control
18 apparatus
19 control unit
20 mechanism

It will be understood that each of the elements described above, or two or more together may also find a useful application in other types of methods differing from the type described above. While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the core of the present invention that others can, by applying current knowledge, readily adapt it for applications without omitting feature that, from the standpoint of prior art, fairly constitute essential characteristics of the generic or specific aspects of this invention.

What is claimed is new and desired to be protected by Letters Patent is set forth in the appended claims:

1. A solar lighting light up blinds which comprises:
a) means comprising a solar panel mounted on said head channel facing the window to receive the solar radiation and plurality of interconnected solar cells within said solar panel, each solar panel converting the solar radiation into electrical energy;
b) means comprising a led bulbs within said head rail and electrically connected to said solar cells within said solar panel so as to be operated by the electrical energy for lighting the led bulbs in said mini blinds or various types of window blinds, so that at sunrise and all through the day, said solar panel will charge by the sunlight and at sunset all through the night said led bulbs will illuminate within the home or building.

2. A solar lighting light up blinds as recited in claim 1, further including a on/off switch in said head rail, which can be manually controlled or controlled by a wireless remote control.

3. A solar lighting light up blinds as recited in claim 2, further including a hand held wireless remote control that has an array of buttons for adjusting various settings such as on/off feature, and the changing of led light patterns.

4. A solar lighting light up blinds as recited claim 3, further including that led bulbs can be multi colored or single colored that has several different light patterns in said head rail. The attended use is for security reasons, power outages, everyday use, for special enjoyment.
